(19) United States
(12) Patent Application Publication
(10) Pub. No.: US 2017/0081864 A1
(43) Pub. Date: Mar. 23, 2017

(54) Light touch sealant applicator device

(71) Applicant: Rohm and Haas Company, Philadelphia, PA (US)

(72) Inventors: Michael Damian Bowe, Doylestown, PA (US); Janah C. Szewczyk, Philadelphia, PA (US); David A. Verbaro, Cinnaminson, NJ (US)

(73) Assignee: Rohm and Haas Company, Philadelphia, PA (US)

(21) Appl. No.: 15/368,407

(22) Filed: Dec. 2, 2016

Related U.S. Application Data
(63) Continuation-in-part of application No. 12/657,159, filed on Jan. 14, 2010, now abandoned.
(60) Provisional application No. 61/205,549, filed on Jan. 21, 2009.

(51) Int. Cl. E04F 21/08; B05B 15/06; B05C 17/10; B29C 44/18; B05D 7/00; B05D 5/00; B29C 70/74; B05B 7/00; B05D 1/26

(52) U.S. Cl. CPC E04F 21/08; B05B 7/0018; B05B 15/067; B05B 15/061; B05C 17/10; B05D 1/26; B05D 7/54; B05D 5/00; B29C 70/745; B29C 44/18; B29K 2007/00

(57) ABSTRACT

The present invention provides a device for applying a fluid sealant with a light touch, the device comprising a wand with a fluid sealant supply, either as part of the wand or as a separate supply tube, attached to the top of an applicator head via a universal joint, wherein the applicator head has a chamber on its underside which is sufficiently large to enable a constant supply of a fluid sealant to a substrate that is to be sealed, and the applicator head has a chamber edge disposed around its lower periphery adapted to strike the sealant flat. In addition, the present invention provides methods of using the devices to form a seal, e.g. a weather-resistive barrier on a sheathed building structure, by applying a flexible and compressible foam to gaps in the structure. The foam may comprise one or more aqueous polymer having a glass transition temperature of less than 25° C.

The present invention relates to devices for applying a fluid sealant with little or no manual pressure or strain, and to methods for using the devices to provide a seal, such as a weather resistive barrier. More particularly, it relates to devices for applying foam sealants comprising a long handle or wand attached via a universal joint to the top side of an applicator head that has a chamber on its underside for continuously applying a sealant at any angle to gaps in a substrate, while moving the device in any desired direction.

Building structures are commonly constructed with exterior wood, wood composite, cement or gypsum-based sheets, a.k.a. sheathing, that are overlaid with decorative facades or claddings (e.g., wood, aluminum or vinyl sidings or brick facades). While under construction, such buildings require a weather resistive barrier. Several kinds of weather resistive barriers have been proposed, including flexible sheeting material and fluid materials, such as liquids and muds; however, each known weather resistive barrier solution is labor intensive.

Known weather resistive barriers may comprise flexible sheeting material (e.g., Tyvek™ from DuPont, felt or tar paper) that is nailed or stapled to the construction sheathing before the cladding is mounted. Such sheeting material provides some protection, including resistance against wind and water penetration, while the building is under construction and after the cladding is mounted. In addition, such sheeting is must be fastened by hand to all exterior portions of the treated structure and has proven to be labor intensive to apply. This means that the user must physically attach the sheeting to every portion of the exterior structure; this may require accessing hard to reach areas and can be dangerous if a ladder or scaffold is required for such access. Further, the sheeting does not seal the structure and is not a very good wind or water barrier.

Other known weather resistive barriers comprise liquid coatings on the wood, cement or gypsum sheathing, while gaps between building panels are closed by applying tape or a heavy bead of caulk to the gaps. Such tapes often require a separate coating that must be applied with a trowel or scraper that dries to form a hard sealant over the tape. The resulting taping and coating process is labor intensive and, as in the case of sheeting, the user must physically trowel or scrap every gap on the exterior of the structure and even in hard to reach areas.

Recently, compressible latex foams have been proposed as water or air penetration sealants for gaps in sheathing and windows in building structures under construction or to allow a subsequently applied coating to be applied continuously from one panel to the next. Because the foams can be used without tape and because they compress neatly against the surface of sheathing or the windows to seal gaps therein or around them, the foams permit of application without concern for the neatness required in applying caulk, mud or foams that do not compress, and without the need for troweling or scraping.

Known applicators for foam sealants include those disclosed in U.S. Pat. No. 6,284,077 B1, to Lucas et al. comprise spray canisters (102 in FIG. 1 of Lucas et al.) that eject foam through a straw or tube. These canisters generally build the foam so that it is taller than the surfaces adjacent the gap sealed. The Lucas et al. foam retains at least 45% of its original volume after 24 hours; thus, where the foam is intended to be flush with adjacent surfaces, the excess must be struck off flat with a trowel or blade (322 in FIG. 3 of Lucas et al.) in a second step. Nevertheless, to date no device exists to apply a foam sealant so that it is flush with the structure surface in a single action.

The present inventors have sought to solve the problem of safely and efficiently sealing every gap in a sheathed building or other structure to actually make it weather resistant while at the same time creating a surface suitable for siding or cladding and have found a device adapted to solve this problem.

### STATEMENT OF THE INVENTION

The devices of the present invention comprise a handle or wand with a fluid sealant supply, either as part of the wand or as a separate supply tube, and an applicator head, wherein the wand is attached to the top of an applicator head via a universal joint, further wherein the applicator head includes a chamber on its underside which is sufficiently large to enable a constant supply of a fluid sealant to a substrate that is to be sealed, and, still further wherein, the applicator head has disposed around its lower periphery or around the chamber, an edge or a chamber edge adapted to strike the sealant flat. Preferably, the wand is hollow in an axial direction, whereby the wand delivers the fluid sealant to the applicator head through an opening in the universal joint. Alternatively, the device comprises the wand as a handle and, as a fluid sealant supply, a supply tube attached to the applicator head separately from the wand. The device may also comprise a wand that can deliver sealant into an outlet upstream of the universal joint, such as an opening actuated by a bypass valve, and then into a supply tube attached to the applicator head.

The applicator head of the device of the present invention has an underside that is open to the substrate and that defines the chamber of the device. The applicator head can be any of an inverted cup, an inverted cone, an inverted bell, an inverted open rectangular pyramid or an inverted polygonal sided pyramid.

The chamber on the underside of the applicator head represents open volume and is defined by a gap between the underside of the applicator head, the chamber edge itself and a plane that is parallel to the bottom most periphery of the chamber edge of the device. The chamber is adapted to fill with sealant, or, preferably, foam and allows the device to float on the foam or sealant being applied.

The chamber edge disposed around the lower periphery of the applicator head has width defined by size of the applicator head, on the outside, and on the inside by the chamber where it meets the plane that is parallel to the bottom most periphery of the chamber edge of the device. The surface area of the plane parallel to the bottom most periphery of the edge of the device and open to the substrate during application of the sealant or, preferably, foam ranges from 40 to 99.9%, or, preferably, 50% or more, or more, preferably, from 75 to 99% of the total surface area of the plane that is parallel to the bottom most periphery of the edge of the device and bounded by the outside of the edge.

Preferably, the universal joint attaching the wand to the top of the applicator head comprises a ball in socket joint through which the sealant can flow.

Preferably, the applicator head of the device is removable.

The chamber edge disposed around the lower periphery of the applicator head may be integral with the applicator head and may comprise the bottom edge of the applicator head. The chamber edge is made of a material sufficiently hard to strike flat any sealant that is applied to a substrate.

The chamber edge can comprise a flexible element adapted to strike, such as a squeegee or rubber wiper blade. The width, height and stiffness of the chamber edge can be chosen to suit the substrate roughness and fluid viscosity so that the fluid is stricken to the desired thickness. The wiper or brush can be fitted into a slot in the edge, so that it can be easily changed or removed for cleaning.

The chamber edge can comprise any shape that can bound a chamber within a single plane, such as annular, triangular square or polygonal. The chamber edge can comprise, for example, any of a short brush, a hard plastic ridge, a rubber ridge, preferably, a hard rubber, such as nitrile rubber, a ring squeegee.

Preferably, the chamber edge has short brush bristles disposed within it in a normal relation to the bottom plane of the applicator head. In operation, the brush bristles are, disposed normal to the surface of the substrate to be sealed to thereby accommodate outside corners in the substrate or undulation or variation in the substrate surface.

In a preferred embodiment, the wand or supply tube has disposed within it one or more foam generator that comprises a static mixer, such as a bead matrix.

According to another embodiment, the present invention provides methods of forming a seal, such as a weather resistive barrier, comprising applying a compressible sealant composition, preferably an aqueous polymer foam composition, to a gap, crack or joint in a substrate structure, such as a sheathed building structure under construction or remodeling, with the devices of the present invention while, in the same motion, striking the applied foam flat or flush with the surface of the structure, optionally, followed by coating or covering the remaining surface of the structure, e.g. a building, to form a weather resistive barrier, such as, preferably, with a paint or coating material. The applying to the gaps can be performed moving along the gaps of the structure in any direction.

The methods preferably comprise applying the sealant with little or no applied pressure aside from that applied by the weight of the applicator head, i.e. a touch of the applicator device to the substrate surface.

The applying to the gaps can be performed at a rate of 0.08 m/s or more, or up to 2.5 m/s, preferably at a rate of 0.5 m/s or more.

The methods can comprise applying the sealant composition to a vertical surface, such as a wall, or ceiling.

### BRIEF DESCRIPTION OF THE DRAWINGS

FIG. 1A depicts a preferred embodiment of a device in accordance with the present invention having a foam generator.

FIG. 1B depicts another embodiment of a device in accordance with the present invention having a bypass valve 12 in wand 1.

FIG. 2 depicts the top of an embodiment of an applicator head 3 in accordance with the present invention

FIG. 3A depicts a cross section of the applicator head 3 shown in FIG. 2.

FIG. 3B depicts a cross section of a preferred embodiment of the applicator head 3 shown in FIG. 4.

FIG. 4 depicts the underside of a preferred embodiment of an applicator head 3 in accordance with the present invention.

FIG. 5 depicts an embodiment of a preferred ball in socket universal joint 2 (FIG. 1) in accordance with the present invention.

FIG. 6 depicts an alternative embodiment of the fluid sealant supply into the applicator head in accordance with the present invention.

All ranges recited are inclusive and combinable. For example, the recitation of a velocity of 0.08 m/s or more, or up to 2.5 m/s, preferably, 0.5 m/s or more, includes all of the ranges of 0.08 to 2.5 m/s, 0.08 to 0.5 m/s, and 0.5 to 2.5 m/s.

Unless otherwise indicated, any term containing parentheses refers, alternatively, to the whole term as if no parentheses were present and the term without them (i.e. excluding the content of the parentheses), and combinations of each alternative. Thus, the term (co)polymer refers to a homopolymer or copolymer.

As used herein, the phrase “aqueous” includes water and mixtures comprising water and one or more water-miscible solvent.

As used herein, the term “emulsion polymer” means a polymer made in water or an aqueous mixture by an emulsion polymerization process.

As used herein, unless otherwise indicated, the phrase “glass transition temperature” or “Tg” refers to the calculated glass transition temperature of any (co)polymer as determined using the Fox equation (T.G. Fox, Bull. Am. Physics Soc., Volume 1, Issue No. 3, page 123 (1956)).

As used herein, “wt %”, “wt. %” or “wt. percent” means weight percent.

The devices of the present invention enable the rapid application of fluid sealants to gaps of highly variable widths in any building structure along which the applicator head can be moved. Such structures may include, for example, sheathed building structures under construction or renovation, such as, for example, homes, schools, warehouses, office buildings, and commercial spaces, but may include any structure that needs sealing. The device comprises a chamber in the underside of an applicator head which chamber is a space that is open on its underside to the substrate and that can fill with sealant, e.g. foam, and thereby continuously replenish the sealant supplied to the substrate surface. Thus, if the applicator head is 0.1 meter wide and has a chamber that is 0.09 meter wide, the devices can be used to continuously apply fluid sealants to any gap or substrate that is less than 0.09 meter wide. Because the device contacts the substrate all around the chamber, the device can be moved in any direction. The chamber edge is adapted to fill with sealant, or, preferably, foam and allows the device to float on the foam or sealant being applied, rather than on the substrate itself. In addition, the devices of the present invention are very light, so a long wand can be used to enable easy access to hard to reach places or high points on the substrate. Accordingly, when the devices of the present invention are used to apply compressible fluid sealants, e.g. compressible foams, a very small amount of pressure no more than the weight of the device itself need be applied to seal the gaps in the substrate; the devices are easy to use.

In use of the devices of the present invention, an operator can move the device up-down and left-right while continuously extruding and striking off a bead of fluid sealant. Further, the devices comprise a universal joint attaching the applicator head to a wand so as to enable the applicator head to be moved in any direction in relation to the wand and at any angle above which no mechanical hindrance will occur between the wand and the applicator head, e.g. from 90° or normal to the substrate surface to 30° or less or such that the wand is almost parallel to the substrate surface. The applicator head only turns when operator turns the wand.

The chamber edge on the underside of the applicator head of the devices can be formed of a durable material, such as wood, plastic, hard rubber, or sheet metal, e.g. aluminum, whereby it can be readily slid or skimmed along the surface of the substrate to be sealed at any speed within an operator's ability. For example, an operator can walk briskly along while applying the sealant.

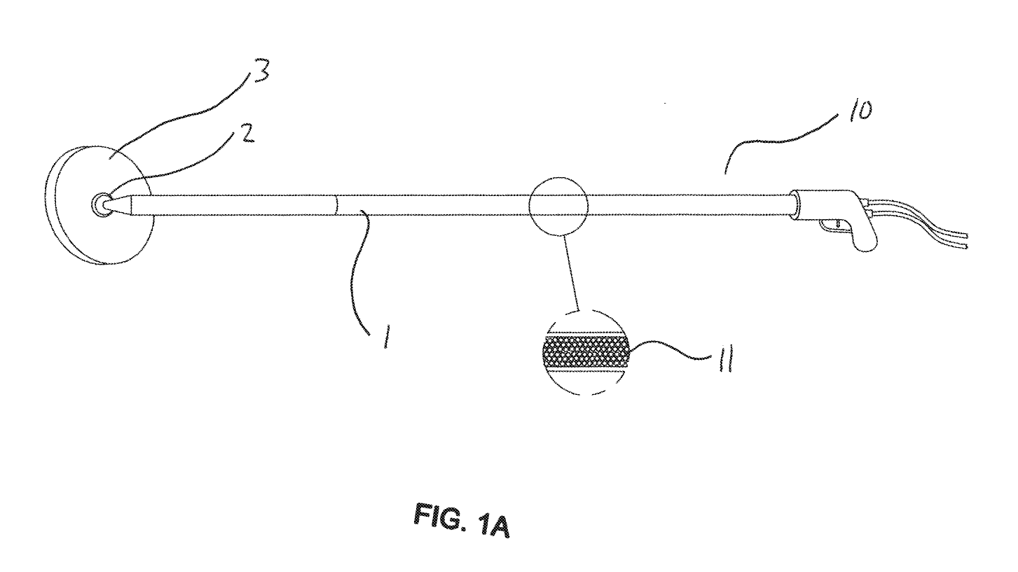

As shown in FIG. 1A, device 10 comprises a wand 1 adapted to deliver a fluid sealant to a substrate such that the wand 1 has within in a foam generator 11 of a bead matrix. The bead matrix in foam generator 11 will form a foam when known polymer compositions are passed through it, such as aqueous polymer emulsions which include surfactants or propellant gases. Device 10 further comprises a universal joint 2 that connects wand 1 to applicator head 3.

As shown in FIG. 1B, device 10 may be equipped with a bypass valve 12 in wand 1 to shut off flow of fluid sealant to applicator head 3 and permit it to flow through tube 16 extending from bypass valve 12. The bypass valve is actuated by stopcock 13. In this embodiment, a user can applying fluid sealant to a narrow area or inside corner in a substrate structure that cannot be accessed using applicator head 3.

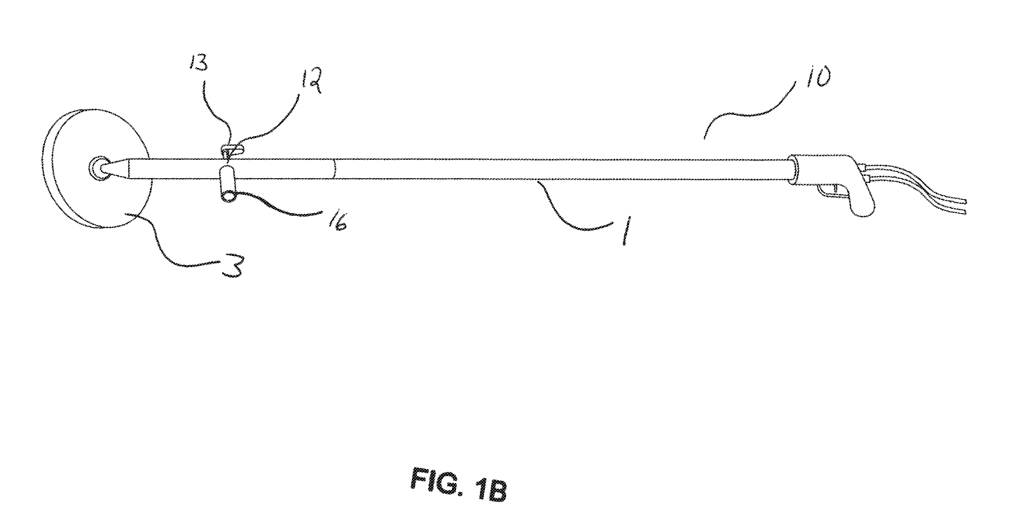

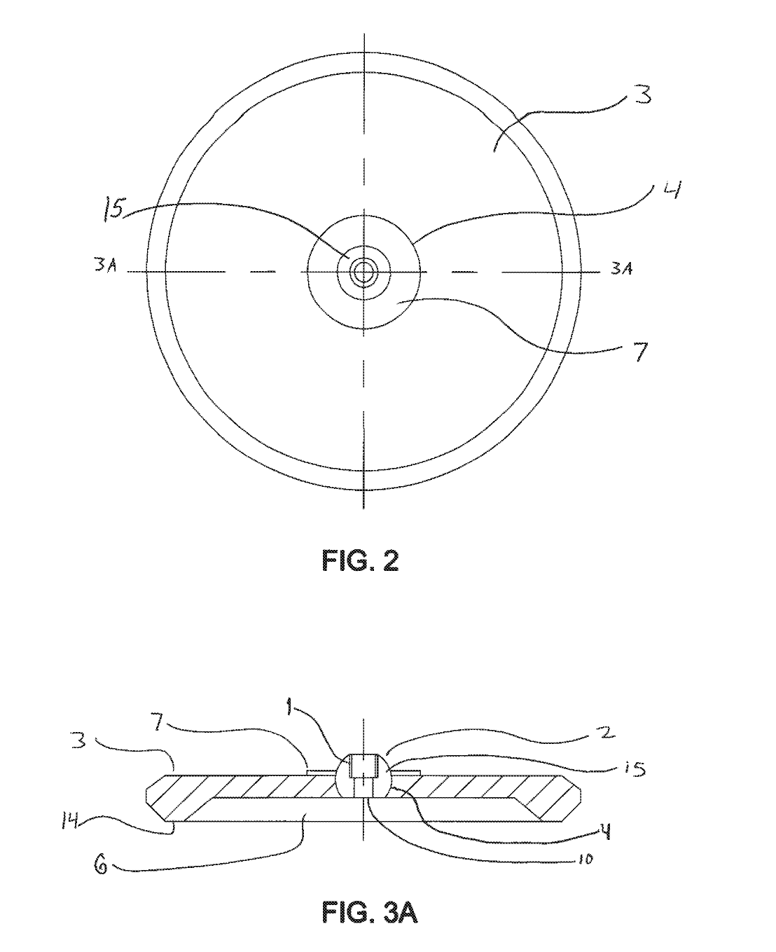

As shown in FIG. 2, top of applicator head 3 in accordance with an embodiment of the present invention includes recess 4 adapted to receive ball 15 of a ball in socket universal joint 2, as shown in FIGS. 1A, 1B 3A and 3B. Universal joint 2 is held in place by retainer clip 7 which is apertured to allow wand 1 (FIG. 3A) to pass therethrough while holding ball 15 in place.

As shown in FIG. 3A, applicator head 3 in accordance with the embodiment shown in FIG. 2 comprises chamber 6 in its underside and a chamber edge 14 disposed about the lower periphery of chamber 6. In addition, FIG. 3A depicts a ball in socket universal joint 2, wherein ball 15 is attached to or forms part of wand 1 and includes an opening 10 to permit flow of fluid sealant into chamber 6. In accordance with this embodiment, the ball in socket universal joint 2 is constructed by fitting ball 15 into recess 4 in the top of applicator head 3 and is held in place via retainer clip 7.

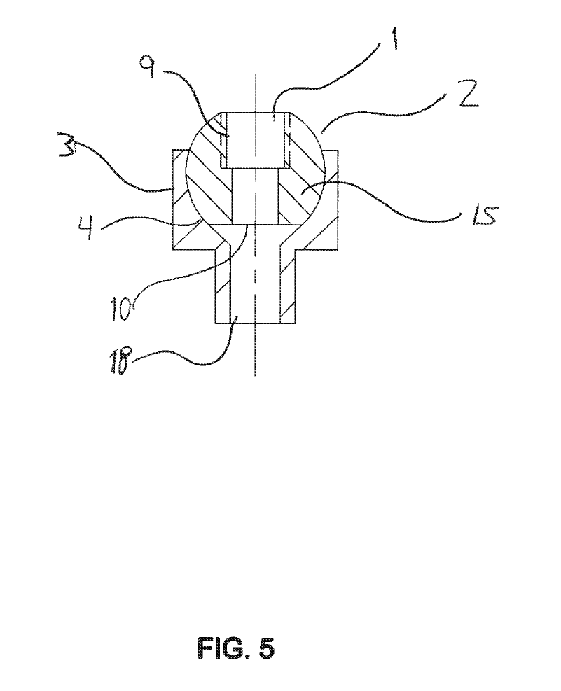

As shown in FIG. 5, a preferred ball in socket universal joint 2, fits into a recess 4 in the top of applicator head 3 (cut away view shown). Wand 1 is, in the embodiment shown, threaded 9 to attach to ball 15, which snap fits into applicator head 3 with resistance and a snug fit provided by recess 4 the side of which extends just beyond vertical to create a socket into which ball 15 snaps. The ball 15 comprises opening 10 in fluid connection with wand 1 to enable fluid sealant to flow into an outlet 18 leading into the top of the chamber or, when applicator head 3 is removed, directly out of the ball 15 on the end of the wand. In an alternative embodiment, the ball can be large enough to protrude into the chamber so that the opening in the ball is disposed directly within the chamber to enable flow of fluid sealant from the ball directly into the chamber.

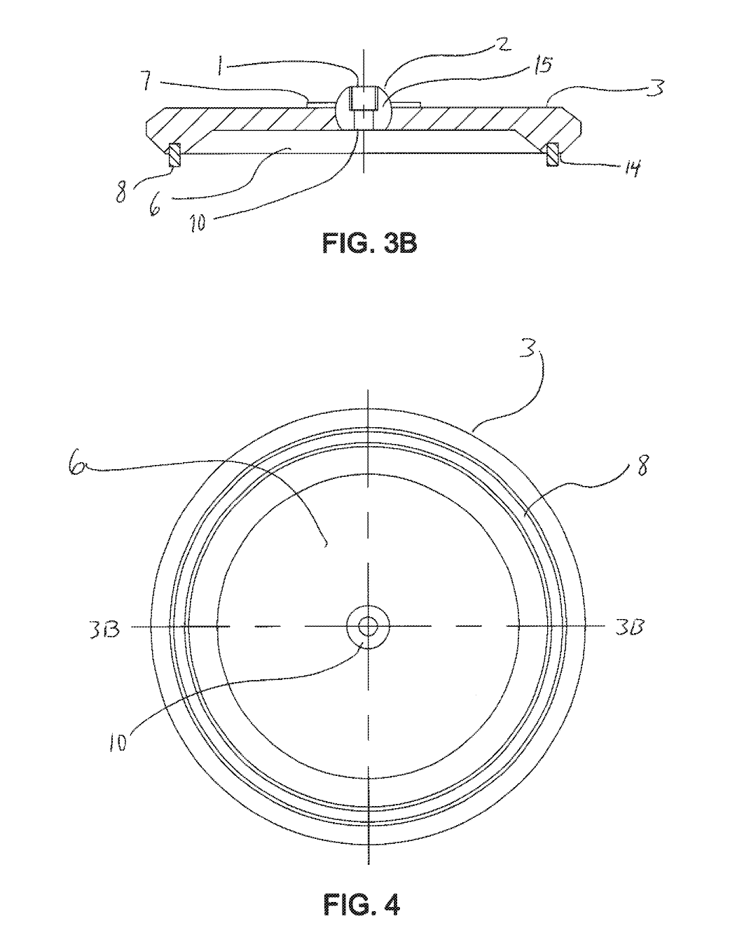

As shown in FIG. 3B, applicator head 3 in accordance with the embodiment shown in FIG. 4 comprises chamber 6 in its underside having a chamber edge 14 disposed about the lower periphery of chamber 6, and a row of brush bristles 8 extending from chamber edge 14 in a downward direction to allow the user to apply fluid sealant and strike it flat even when the substrate is uneven. In addition, FIG. 3B depicts a ball in socket universal joint 2, wherein ball 15 is attached to or forms part of wand 1 and includes an opening 10 to permit flow of fluid sealant into chamber 6.

The brush bristles 8 allow one to apply fluid sealant to an outside corner by drawing applicator head 3 along one side the outside corner such that one section or portion of brush bristles 8, but no part of chamber 6, extends just over the edge of the corner in a direction normal to the one side of the outside corner and parallel to the other side of outside corner just above its surface. In such a way, the brush bristles 8 form a dam to strike fluid sealant flat on the surface of the perpendicular wall along the corner gap and to prevent fluid sealant from flowing out onto the other side of the outside corner, such that a corner bead is easily formed. In the embodiment depicted, universal joint 2 and applicator head 3 are as depicted in FIG. 2 and FIG. 3A.

As shown in FIG. 4, the underside of applicator head 3 in accordance with an embodiment of the present invention shown in FIG. 3B comprises chamber 6 in its underside having a chamber edge 14 (FIG. 3B) disposed about the lower periphery of chamber 6, and a row of brush bristles 8 which extend from chamber edge 14 all around its lower periphery. Accordingly, a user can drag the device in any direction and still strike applied fluid sealant flat or flush with the substrate.

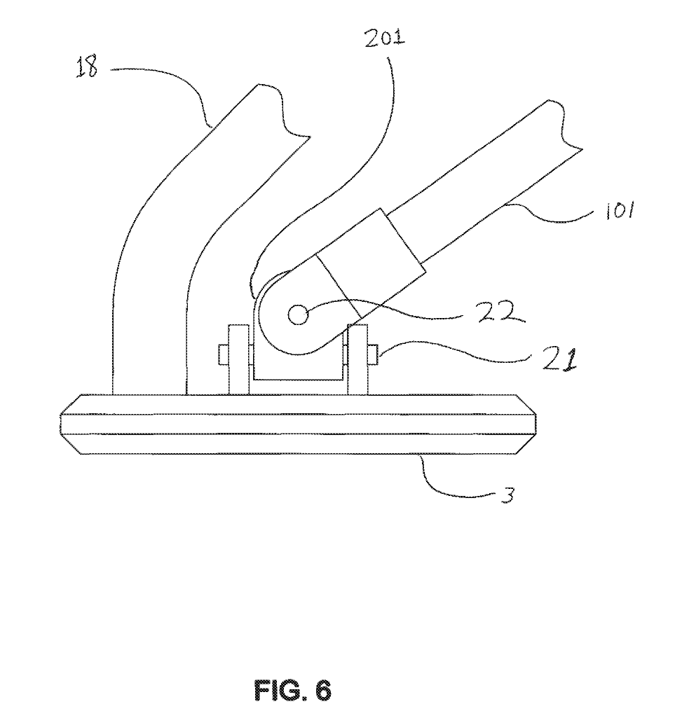

As shown in FIG. 6, in an alternative embodiment, wand 101 and a flexible foam supply hose 18 are separately attached to the applicator head 3.

In some embodiments, a universal joint may comprise a conventional swivel joint 201 such as, for example, that shown in FIG. 6 comprising two orthogonally disposed pivot axes 21 and 22 that rotate to allow the angle between wand 101 and applicator head 3 to be continuously adjustable throughout a range limited only by constriction caused by the applicator head, substrate and any fluid sealant supply hose in use.

A suitable swivel joint in accordance with the present invention can be attached to the applicator head by a roll pin through one of the pivot axes which may be friction fit into apertures cast or attached to the top of applicator head. In such an embodiment, a fluid sealant supply hose may be used separately from the wand or the fluid sealant supply may flow through the wand and out of the wand above the universal joint and then into a boot that completely encloses the wand and the universal joint, like a stick shift boot.

In a preferred embodiment, the applicator head of the device in accordance with the present invention is removable from the wand. For example, the wand is connected to the applicator head by a ball in socket joint with the ball attached to or comprising the end of the wand.

In a particularly preferred embodiment, the ball forms the end of the wand and clicks on and off a socket in the applicator head so that, when unattached to the applicator head, the wand with the naked opening in the ball at its end can be used to apply sealant to an inside corner or constricted area.

A ball in socket joint in accordance with the present invention may be attached into the female recess in the top of the applicator head via any known means. For example, the ball may snap into one or more spring loaded bearing, e.g. a ring of bearings, disposed within the periphery of the female recess in the top of the applicator head. In another embodiment, the ball may be held in place by a removable annular retaining clip, like the one shown in FIG. 3A, having a round opening large enough to permit movement of the wand throughout 360° and at any desired angle to the substrate fit into the recess in the top of the applicator head. In operation, the clip can be held by two or more pins extending downwardly from annular clip into the applicator head to attach into corresponding openings in the top of the applicator head. In yet another embodiment, the retaining clip can be slid into place and held by a small lip extending downward at its periphery to catch a correspondingly shaped plastic tab or ridge molded into the top of chamber to fit snugly under the lip when the clip is closed. Where used, a retaining clip is preferably spring loaded to remain shut and slides open to admit the ball end of the wand into the recess in the top of the chamber. In another suitable ball in socket joint, the ball itself may be fitted onto the wand in a conventional manner. For example, each of the wand and the ball could be threaded.

Most preferably, a socket or recess for receiving a ball on the wand comprises at its topmost portion a ring or annular portion sized to hold the ball in place, e.g. being just smaller than the outer diameter of the ball. The ball may snap in place, i.e. ball and socket could snap together as the ball fits snugly into the socket. Alternatively, the ring portion of the recess may comprise two or more spring loaded tabs disposed at the periphery of the opening in the socket above where the equator line or the midpoint of the ball would come to rest when it is fit into the opening, thereby allowing the ball to snap in to the socket.

The wand of the device in accordance with the present invention may be tubular or have an axial cavity or conduit within it so as to admit fluid sealant flow through it and into the applicator head. Alternatively, the wand has a bypass valve upstream of the applicator head which may simply be a hole in the side of the wand that is held closed when not in used with a removable plug and into which a tube may be inserted to draw foam for application via the tube to any desired gap.

The applicator head of the device in accordance with the present invention and its chamber can be in any shape, i.e. square, rectangular, round or ellipsoid so long as the chamber is wider than the gaps the user seeks to seal.

In some embodiments, the applicator head can have a beveled edge around its lower periphery, like a ski tip, to ease movement along the substrate.

In another embodiment, the applicator head may have a chamber edge on its underside with lower surface profiles other than flat, to allow application over a gap between non-coplanar panels. Such non-flat substrates can be the outside or inside corner of a house, for example. In one embodiment, a single hinged applicator head can access many angles.

The device, including wand, clip, applicator head and the universal joint, can be made of any lightweight durable material, such as sheet metal, e.g. aluminum, or hard plastic.

The lower periphery of the applicator head can comprise various materials that permit the device to slide over or ride over the substrate surface, and can be comprised of, for example, hard plastic or metal, either as part of or made of the same material as the applicator head itself; brush bristles; hard rubber or hard form, such as gasket or squeegee material. Brush bristles are preferred.

Suitable foam generators may comprise any known simple batch mixer or an aerosol can be used to make a suitable foam sealant. For example, a continuous foamer model no. 2M*172 from E.T. Oakes Corp., Hauppauge, N.Y., or static mixers, as disclosed in U.S. Pat. No. 5,492,655 (Schuller International Inc.), U.S. Pat. No. 4,986,667 (3M), and U.S. Pat. No. 6,422,734 (National Gypsum LLC). Still other foam generators include venturi or air eductors to draw and mix air into a fluid stream, such as disclosed in U.S. Pat. No. 6,010,083 (BetzDearborn Inc.), U.S. Pat. Nos. 6,042,089, and 6,561,438 (Fountainhead Group). The foam can also be dispensed from a pressurized aerosol container, as disclosed in U.S. Pat. No. 7,029,609 (Rathor) and references contained therein.

Preferably, the foam generator comprises a static mixer contained in the wand or foam supply tube, such as a bead matrix. When using a static mixer air or propellant and latex are combined and fed to a mixing bed, for example, in the wand of the device. At the outlet of packed bed, foam is already well made, under low pressure, e.g. 140 kPa (kilopascals) or 0.14 MPa (20 psi). A suitable mixing bed may be 1.5 to 3 cm wide and 3 to 12 cm long, packed with 1-2 mm plastic beads.

The methods of the present invention comprise applying a compressible and flexible fluid sealant, e.g. a foamed sealant polymer composition, preferably an aqueous emulsion polymer composition, with the devices of the present invention to gaps of a building structure under construction or remodeling while, in the same motion, striking the applied foam flush with the surface of the structure, optionally followed by coating or covering the remaining surface of the building to form a weather resistive barrier, such as, preferably, with a paint or coating material.

The methods of applying the sealant and striking it flat or flush with the substrate comprise applying the sealant with little or no applied pressure, i.e. a touch of the applicator chamber edge surface. Accordingly, suitable sealant compositions may include, for example, any foam that can be compressed to a thickness of not more than 3 mm under a stress of no more than 0.035 MPa, preferably, of no more than 0.0035 MPa. Suitable foamed compositions are made with aqueous flexible polymers, such as the elastomeric aqueous emulsion polymers like those used in coatings and paints, as described below.

In operation, sealant or foam is pumped or fed through a wand or tube into an applicator head having a chamber open on the side adjacent a substrate with a peripheral lower surface or edge that conforms to the substrate, i.e. the side of a building, and is applied to seal a crack or gap in the substrate surface via the lower surface of the device. When the chamber edge is moved along the gap, excess foam is stricken flat. The device can be moved in any direction at any time, i.e. translationally, over the structure surface to seal gaps in any orientation and can be operated with no normal pressure beyond the weight of the tool itself, i.e. with a feather light touch.

In the methods of sealing gaps in a sheathed structure, the device can be moved along the gaps at a rate of 0.08 m/s or more, or up to 2.5 m/s, preferably at a rate of 0.5 m/s or more, or up to 2.0 m/s. A brisk walking speed is 1.6 m/s. Rapid application of the sealant is possible because the chamber is replenished with foam to continuously fill the gaps.

The devices may be used to apply fluid sealant to any substrate that demands a leveling or sealing application of a sealant, such as, joint, gaps or cracks in any substrate chosen from sheathed building structures, the interior of buildings, floor joints, e.g. in self-leveling floor applications, stud bays, rafters, attic joints, highways, walkways, cinder block structures, joints in cinder block structures, and concrete structures. Highways or walkways can be concrete or asphalt. Especially suitable substrates may include any building under construction that employs adjacent sheets of wood, plywood, oriented strand board (OSB), cement or gypsum exterior sheathing on a structural frame with gaps between the sheets.

The polymers can be foamed with surfactants, such as non-ionic surfactants; or propellants, such as, for example, air or carbon dioxide. Preferably, the aqueous emulsion polymer foams are sufficiently flexible that, after drying at least one day, a foam strip formed on a mesh backing can be wrapped around a cylindrical metal mandrel with a diameter of 100 mm without cracking. For cold weather applications, a suitable foamed composition (a) can, after drying at least one day, be formed into a foam strip comprising a mesh backing and wrapped around cylindrical metal mandrel with a diameter of 50 mm without cracking.

Suitable coatings or coverings to form a weather resistive barrier preferably comprises paint or coating material, such as an aqueous emulsion polymer paint or coating, and, preferably, an aqueous emulsion of an elastomeric or flexible polymer, such as one having a glass transition temperature or Tg of 25° C. or less. In other embodiments, the covering of the weather resistive barrier comprises tar paper, or other weather resistant barrier such as polyolefin wovens like Tyvek™ from DuPont, Wilmington, Del.

Suitable polymeric coating composition or paints for covering the remaining surface of the building having a density when dried of greater than 0.7 g/ml, preferably an elastomeric coating composition, over the sealed structure, e.g. sheathing. Suitable polymeric coatings may be selected so as to allow for an appropriate water vapor transmission for the building and may comprise, for example, rubbery polymer emulsions, flexible, acrylic polymer emulsions such as Rhoplex™ EC-2540 from Rohm and Haas Company, Phila., Pa., styrene-acrylic copolymers, such as Sto Gold Coat from Sto Corp of Atlanta, Ga., and acrylic and/or asphalt emulsion coatings, such as Henry Airbloc 33 (an acrylic copolymer) or Henry Airbloc 06WB (an asphalt emulsion), each from Henry Inc. of Huntington Park, Ca, vinyl acetate-acrylics, ethylene-vinyl acetates, styrene-butadienes, and polyurethane dispersions.

Suitable coating or paint compositions can be applied by any known method, including by spray equipment, brush or roller.

### EXAMPLES

### Example 1

A device in accordance with FIG. 3A has a circular “puck” shaped applicator head with a solid annular chamfered plastic chamber edge extending around the lower periphery of the chamber. The overall diameter of the plane that is parallel to the bottom most periphery of the chamber edge of the device and bounded by the outside of the chamber edge is 16.2 cm, The inner diameter of the chamber edge is 12.8 cm and the outside diameter of the chamber edge is 16.2 cm. Thus, the chamber edge width in contact with substrate is 1.7 cm.

The area of the total plane defined by the underside of the chamber and chamber edge is 3.14*(8.1)² or 206 cm². The surface area under the chamber and exposed to the substrate is 129 cm². The surface area under the chamber edge is 77 cm². Accordingly, the surface area open under the chamber is 63% of the total surface area of the plane parallel to the bottom most periphery of the edge of the device and open to the substrate during application of the sealant of the edge.

When used to dispense acrylic foam, the device rides over bumps and nails on a sheathed wall substrate ut does not leak foam out of the chamber in any direction.

### Example 2

In an device as shown in FIG. 3B, with both round and square chambers worked to allow the device to ride on the foam being dispensed. A square chamber was 11.0 cm on a side and had a 1.0 cm wide edge fitted midway of its width with a row of bristles 0.2 cm wide and 0.3 mm tall, perpendicular to the chamber edge and also to the substrate when the device was used to apply acrylic foam. The row of bristles went completely around the perimeter of the chamber. The chamber underside tapered from the chamber edge up to the center opening 10, forming an approximately pyramidal open chamber (for square) or conical (for round) such that when the bristles on the lower periphery were in contact with a planar substrate, the apex of the pyramid and opening 10 were about 1.0 cm above the substrate.

The total surface area under the chamber and chamber edge was 100 cm². The surface area of the plane parallel to the bottom most periphery of the chamber edge of the device and open to the substrate during application of the sealant was 40 cm×1 cm wide or 40 cm². In use, only the bristle tips touch the substrate, so there was only (40 cm×0.2) or 8 cm² of contact, or about 8% of the total surface area of the plane parallel to the bottom most periphery of the edge of the device and open to the substrate during application of the sealant. Thus, 92% of such surface areas was open to the substrate.

We claim:

1. A device for applying a fluid sealant to a substrate comprising a wand with a fluid sealant supply either as part of the wand or as a separate supply tube and an applicator head, wherein, the wand is attached to the top of an applicator head via a universal joint,
further wherein, the applicator head defines a chamber on its underside that is open to the substrate which is sufficiently large to enable a constant supply of a fluid sealant to a substrate that is to be sealed, and,
still further wherein, the applicator head has disposed around its lower periphery a chamber edge adapted to strike the sealant flat.

2. The device for applying a fluid sealant to a substrate as claimed in claim 1, wherein the chamber on the underside of the applicator head represents open volume and is defined by a gap between the underside of the applicator head, the chamber edge itself and a plane that is parallel to the bottom most periphery of the chamber edge of the device.

3. The device for applying a fluid sealant to a substrate as claimed in claim 1, wherein the surface area of a plane parallel to the bottom most periphery of the edge of the device and open to the substrate during application of the sealant ranges from 40 to 99.9% of the total surface area of the plane that is parallel to the bottom most periphery of the edge of the device and bounded by the outside of the edge.

4. The device as claimed in claim 1, wherein the wand is hollow in an axial direction, whereby the wand delivers the fluid sealant to the applicator head through an opening in the universal joint.

5. The device as claimed in claim 1, wherein the wand is a handle and, as a separate fluid sealant supply, a supply tube is attached to the applicator head separately from the wand.

6. The device as claimed in claim 1, wherein the universal joint attaching the wand to the top of the applicator head comprises a ball in socket joint through which the sealant can flow.

7. The device as claimed in claim 1, wherein the applicator head is removable.

8. The device as claimed in claim 1, wherein the chamber edge disposed around the lower periphery of the applicator head has short brush bristles disposed within it in a normal relation to the bottom plane of the applicator head.

9. The device as claimed in claim 1, wherein the wand or supply tube has disposed within it within it one or more foam generator that comprises a static mixer.

10. A method of forming a seal comprising applying a compressible sealant composition to a gap, crack or joint in a substrate with the device as claimed in claim 1, while, in the same motion, striking the applied foam flat or flush with the surface of the substrate, optionally, followed by coating or covering the remaining surface of the substrate to form a weather resistive barrier.
